(19) United States
(12) Patent Application Publication
(10) Pub. No.: US 2023/0238830 A1
(43) Pub. Date: Jul. 27, 2023

(54) AUTOMOTIVE KEY FOB INTERFERENCE PREVENTION IN WIRELESS CHARGERS

(71) Applicant: AIRA, INC., Chandler, AZ (US)

(72) Inventors: Jake Slatnick, San Diego, CA (US); Mohammad Ali Saket Tokaldani, Vancouver (CA)

(21) Appl. No.: 18/101,080

(22) Filed: Jan. 24, 2023

Related U.S. Application Data
(60) Provisional application No. 63/303,018, filed on Jan. 25, 2022.

(51) Int. Cl. H02J 50/12; H02J 50/80; H04B 5/00; H04W 4/80

(52) U.S. Cl. CPC H02J 50/12; H02J 50/80; H04B 5/0031; H04W 4/80

(57) ABSTRACT

Systems, methods and apparatus for wireless charging are disclosed. A charging device has multiple transmitting coils, a driver circuit configured to provide a charging current to the resonant circuit, and a controller configured to provide a charging current to the transmitting coils. The apparatus includes a resonant circuit that includes one or more transmitting coils and a driver circuit configured to provide a charging current to the plurality of transmitting coils. The controller may be configured to provide a charging current to the resonant circuit when a receiving device is present on a surface of the wireless charging device, determine that an interrogation signal is being transmitted by a keyless entry system, suspend the charging current for a period of time, determine that the interrogation signal has ceased while the charging current is suspended, and restore the charging current to the resonant circuit after determining cessation of the interrogation signal.

### PRIORITY CLAIM

This application claims priority to and the benefit of provisional patent application No. 63/303,018 filed in the United States Patent Office on Jan. 25, 2022 and the entire content of this provisional application is incorporated herein by reference as if fully set forth below in its entirety and for all applicable purposes.

### TECHNICAL FIELD

The present invention relates generally to wireless charging of batteries, including batteries in mobile computing devices, and more particularly to avoiding interference with signals related to a key fob during a charging operation.

### BACKGROUND

Wireless charging systems have been deployed to enable certain types of devices to charge internal batteries without the use of a physical charging connection. Devices that can take advantage of wireless charging include mobile processing and/or communication devices. Standards, such as the Qi standard defined by the Wireless Power Consortium enable devices manufactured by a first supplier to be wirelessly charged using a charger manufactured by a second supplier. Standards for wireless charging are optimized for relatively simple configurations of devices and tend to provide basic charging capabilities.

Improvements in wireless charging capabilities are required to support continually increasing complexity of mobile devices and changing form factors. For example, there is a need for techniques for avoiding interference with the operations unrelated to wireless charging and for avoiding collateral damage to devices that may be uninvolved in a wireless charging transaction.

### BRIEF DESCRIPTION OF THE DRAWINGS

FIG. 1 illustrates an example of a charging cell that may be employed to provide a charging surface in accordance with certain aspects disclosed herein.

FIG. 2 illustrates an example of an arrangement of charging cells provided on a single layer of a segment of a charging surface that may be adapted in accordance with certain aspects disclosed herein.

FIG. 3 illustrates an example of an arrangement of charging cells when multiple layers are overlaid within a segment of a charging surface that may be adapted in accordance with certain aspects disclosed herein.

FIG. 4 illustrates the arrangement of power transfer areas provided by a charging surface that employs multiple layers of charging cells configured in accordance with certain aspects disclosed herein.

FIG. 5 illustrates a wireless power transmitter that may be provided in a charger base station in accordance with certain aspects disclosed herein.

FIG. 6 illustrates a keyless entry system that can be adapted in accordance with certain aspects disclosed herein.

FIG. 7 illustrates an example of interference between a wireless charging system and a keyless entry system.

FIG. 8 illustrates a first example in which a wireless charging system is configured to avoid interference with a keyless entry system in accordance with certain aspects disclosed herein.

FIG. 9 illustrates a second example in which a wireless charging system is configured to avoid interference with a keyless entry system in accordance with certain aspects disclosed herein.

FIG. 10 illustrates an effective layout of a loop antenna provided on a surface of a wireless charging device in accordance with certain aspects of this disclosure.

FIG. 11 illustrates certain examples of segments of a loop antenna provided in accordance with certain aspects of this disclosure.

FIG. 12 illustrates trace swapping in segments of a loop antenna provided in accordance with certain aspects of this disclosure.

FIG. 13 illustrates an example of certain segments of a loop antenna formed on a top layer of a printed circuit board in accordance with certain aspects of this disclosure.

FIG. 14 illustrates an example of a loop antenna formed on a two-layer printed circuit board in accordance with certain aspects of this disclosure.

FIG. 15 illustrates examples of filtering techniques in accordance with certain aspects of this disclosure.

FIG. 16 is a flowchart that illustrates an example of a method for operating a wireless charging device in accordance with certain aspects of this disclosure.

FIG. 17 illustrates one example of an apparatus employing a processing circuit that may be adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of wireless charging systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a processor-readable storage medium. A processor-readable storage medium, which may also be referred to herein as a computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), Near Field Communications (NFC) token, random access memory (RAM), read only memory (ROM), programmable ROM (PROM), erasable PROM (EPROM), electrically erasable PROM (EEPROM), a register, a removable disk, a carrier wave, a transmission line, and any other suitable medium for storing or transmitting software. The computer-readable medium may be resident in the processing system, external to the processing system, or distributed across multiple entities including the processing system. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

### Overview

Certain aspects of the present disclosure relate to systems, apparatus and methods related to wireless charging devices that provide a free-positioning charging surface using multiple transmitting coils or that can concurrently charge multiple receiving devices. In one aspect, a controller in the wireless charging device can locate a device to be charged and can configure one or more transmitting coils optimally positioned to deliver power to the receiving device. Charging cells may be provisioned or configured with one or more inductive transmitting coils and multiple charging cells may be arranged or configured to provide the charging surface. The location of a device to be charged may be detected through sensing techniques that associate location of the device to changes in a physical characteristic centered at a known location on the charging surface. In some examples, sensing of location may be implemented using capacitive, resistive, inductive, touch, pressure, load, strain, and/or another appropriate type of sensing.

Certain aspects disclosed herein relate to improved wireless charging systems. Systems, apparatus and methods are disclosed that accommodate free placement of chargeable devices on one or more surfaces provided by a charging system constructed from modular surface elements. In one example, a single surface provided by the charging system is formed from a configuration of multiple modular multi-coil wireless charging elements. In another example, a distributed charging surface may be provided by the charging system using multiple interconnected multi-coil wireless charging elements.

Certain aspects can improve the efficiency and capacity of wireless power transmission to a receiving device. In one example, a wireless charging device has a battery charging power source, a plurality of charging cells configured in a matrix, a first plurality of switches in which each switch is configured to couple a row of coils in the matrix to a first terminal of the battery charging power source, and a second plurality of switches in which each switch is configured to couple a column of coils in the matrix to a second terminal of the battery charging power source. Each charging cell in the plurality of charging cells may include one or more coils surrounding a power transfer area. The plurality of charging cells may be arranged adjacent to a charging surface without overlap of power transfer areas of the charging cells in the plurality of charging cells.

Devices placed on the surface of the wireless charging device may receive power that is wirelessly transmitted through one or more of the charging cells that are provided in a charging surface. Power can be wirelessly transferred to a receiving device located anywhere on the charging surface of the apparatus. The devices can have an arbitrarily defined size and/or shape and may be placed without regard to any discrete placement locations enabled for charging. Multiple devices can be simultaneously or concurrently charged on a single surface. The apparatus can track motion of one or more devices across the surface.

A wireless charging system provided in accordance with this disclosure may include multiple distributed charging surfaces. In one example, at least one of the distributed charging surfaces is implemented using power transmitting coils arranged in three dimensions on a printed circuit board stack. In another example, at least one of the distributed charging surfaces is implemented using power transmitting coils arranged in three dimensions on a multi-layer flexible circuit. The wireless charging system may include a central controller that manages, controls or cooperates with the distributed charging surfaces to detect presence of chargeable devices, determine a charging configuration for each chargeable device placed on one of the distributed charging surfaces and drive a charging current through the power transmitting coils defined by the charging configuration. The level of participation by distributed charging surfaces may depend on complexity of control circuits provided on the distributed charging surface. In one example, a distributed charging surface may include switching circuits that can direct the charging current to selected power transmitting coils in response to control signals provided by the central controller. In another example, a distributed charging surface may include a controller that can communicate with the central controller over a data link and that can implement a charging configuration provided by the central controller. The distributed charging surface may include a controller capable of conducting searches for chargeable devices, determining presence of a chargeable device, decoding information received from a device being charged or other functions of a multicoil, multi-device wireless charging system provided in accordance with certain aspects of this disclosure.

Certain aspects disclosed herein relate to a wireless charging system that can determine or detect the interrogation of a keyless entry key fob and can mitigate wireless interference between the key fob and power transmissions through one or more power transmitting coils of the wireless charging system. A controller in the wireless charging system may be configured to provide a charging current to a resonant circuit when a receiving device is present on a surface of the wireless charging device, determine that an interrogation signal is being transmitted by a keyless entry system, suspend the charging current for a period of time, determine that the interrogation signal has ceased while the charging current is suspended and restore the charging current to the resonant circuit after determining cessation of the interrogation signal.

### Charging Cells

According to certain aspects disclosed herein, a charging device may be provided using charging cells that are deployed adjacent to a surface of the charging device. In one example the charging cells are deployed in accordance with a honeycomb packaging configuration. A charging cell may be implemented using one or more coils that can each induce a magnetic field along an axis that is substantially orthogonal to the surface of the charging device and adjacent to the coil. In this description, a charging cell may refer to an element having one or more coils where each coil is configured to produce an electromagnetic field that is additive with respect to the fields produced by other coils in the charging cell and directed along or proximate to a common axis.

In some implementations, a charging cell includes coils that are stacked along a common axis and/or that overlap such that they contribute to an induced magnetic field substantially orthogonal to the surface of the charging device. In some implementations, a charging cell includes coils that are arranged within a defined portion of the surface of the charging device and that contribute to an induced magnetic field within the substantially orthogonal portion of the surface of the charging device associated with the charging cell. In some implementations, charging cells may be configurable by providing an activating current to coils that are included in a dynamically defined charging cell. For example, a charging device may include multiple stacks of coils deployed across a surface of the charging device, and the charging device may detect the location of a device to be charged and may select some combination of stacks of coils to provide a charging cell adjacent to the device to be charged. In some instances, a charging cell may include, or be characterized as a single coil. However, it should be appreciated that a charging cell may include multiple stacked coils and/or multiple adjacent coils or stacks of coils.

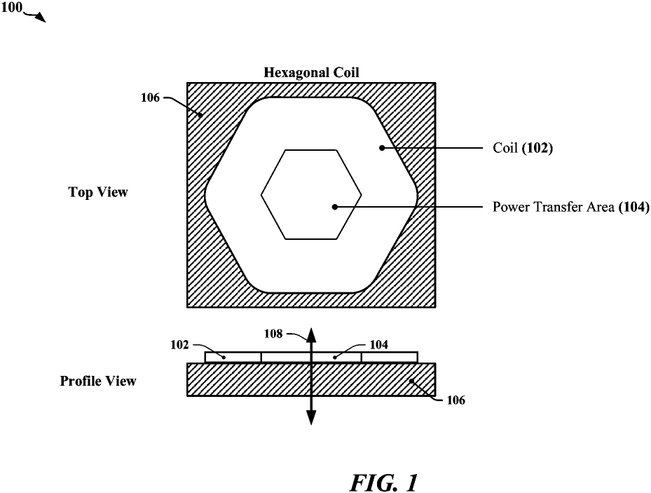

FIG. 1 illustrates an example of a charging cell 100 that may be deployed and/or configured to provide a charging surface included in a charging system. The charging system may provide multiple charging surfaces. In some examples, the charging surfaces may be distributed throughout a room or within a passenger or other compartment of a vehicle.

In some examples provided in this disclosure, a charging surface may be understood to include an array of charging cells 100 provided on one or more substrates 106. A circuit comprising one or more integrated circuits (ICs) and/or discrete electronic components may be provided on one or more of the substrates 106. The circuit may include drivers and switches used to control currents provided to coils used to transmit power to a receiving device. The circuit may be configured as a processing circuit that includes one or more processors and/or one or more controllers that can be configured to perform certain functions disclosed herein. In some instances, some or all of the processing circuit may be provided external to the charging device. In some instances, a power supply may be coupled to the charging device.

In some examples, the charging cell 100 has a substantially hexagonal shape that encloses one or more coils 102 constructed using conductors, wires or circuit board traces that can receive a current sufficient to produce an electromagnetic field in a power transfer area 104. In various implementations, some coils 102 may have a shape that is substantially polygonal, including the hexagonal charging cell 100 illustrated in FIG. 1. Other implementations provide coils 102 that have other shapes. The shape of the coils 102 may be determined at least in part by the capabilities or limitations of fabrication technology, and/or to optimize layout of the charging cells on a substrate 106 such as a printed circuit board substrate. Each coil 102 may be implemented using wires, printed circuit board traces and/or other connectors in a spiral configuration. Each charging cell 100 may span two or more layers separated by an insulator or substrate 106 such that coils 102 in different layers are centered around a common axis 108.

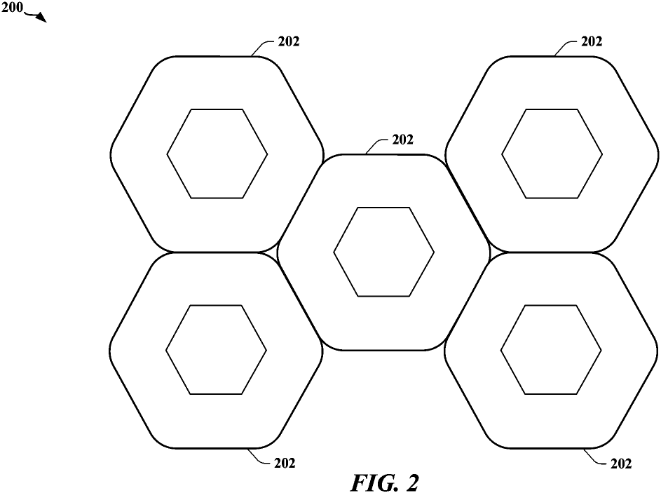

FIG. 2 illustrates an example of an arrangement 200 of charging cells 202 provided on a single layer of a segment or portion of a charging surface that may be included in a charging system that has been adapted in accordance with certain aspects disclosed herein. The charging cells 202 are arranged according to a honeycomb packaging configuration. In this example, the charging cells 202 are arranged end-to-end without overlap. This arrangement can be provided without through-holes or wire interconnects. Other arrangements are possible, including arrangements in which some portion of the charging cells 202 overlap. For example, wires of two or more coils may be interleaved to some extent.

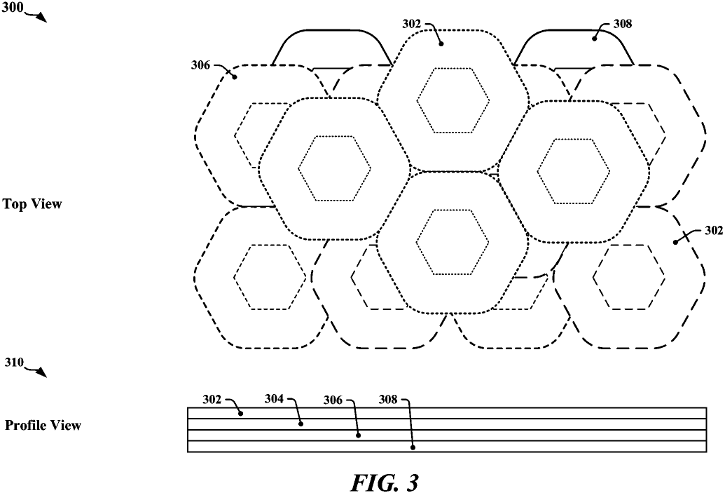

FIG. 3 illustrates an example of an arrangement of charging cells from two perspectives 300, 310 when multiple layers are overlaid within a segment or portion of a charging surface that may be adapted in accordance with certain aspects disclosed herein. Layers of charging cells 302, 304, 306, 308 are provided within a segment of a charging surface. The charging cells within each layer of charging cells 302, 304, 306, 308 are arranged according to a honeycomb packaging configuration. In one example, the layers of charging cells 302, 304, 306, 308 may be formed on a printed circuit board that has four or more layers. The arrangement of charging cells 100 can be selected to provide complete coverage of a designated charging area that is adjacent to the illustrated segment.

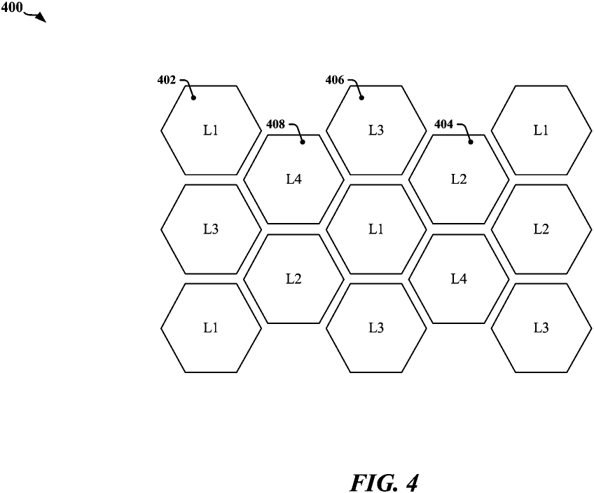

FIG. 4 illustrates the arrangement of power transfer areas provided in a charging surface 400 provided by a charging system. In one example, the charging surface 400 employs multiple layers of charging cells configured in accordance with certain aspects disclosed herein. The illustrated charging surface 400 is constructed using four layers of charging cells 402, 404, 406, 408. In FIG. 4, each power transfer area provided by a charging cell in the first layer of charging cells 402 is marked “L1”, each power transfer area provided by a charging cell in the second layer of charging cells 404 is marked “L2”, each power transfer area provided by a charging cell in the third layer of charging cells 406 is marked “L3”, and each power transfer area provided by a charging cell in the fourth layer of charging cells 408 is marked “L4”.

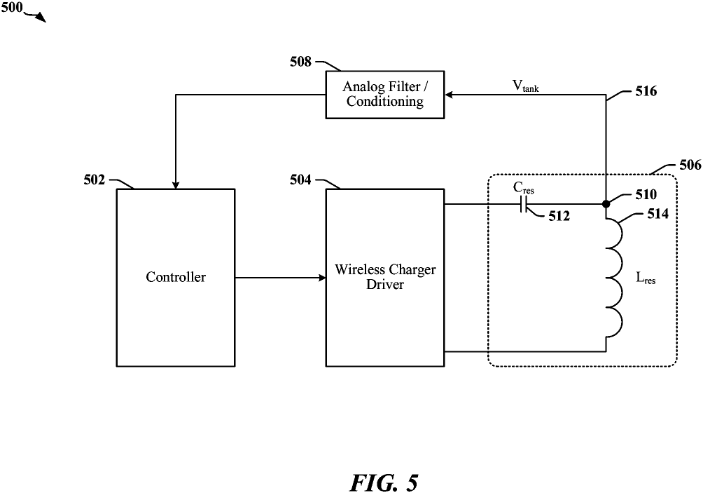

FIG. 5 illustrates a wireless transmitter 500 that may be provided in a charger base station. A controller 502 may receive a feedback signal filtered or otherwise processed by a conditioning circuit 508. The controller may control the operation of a driver circuit 504 that provides an alternating current (AC) signal to a resonant circuit 506 that includes a capacitor 512 and inductor 514. The resonant circuit 506 may also be referred to herein as a tank circuit, an LC tank circuit and/or as an LC tank, and the voltage 516 measured at an LC node 510 of the resonant circuit 506 may be referred to as the tank voltage.

The wireless transmitter 500 may be used by a charging device to determine if a compatible device has been placed on a surface of the charging device. For example, the charging device may determine that a compatible device has been placed on the surface of the charging device by sending an intermittent test signal (active ping) through the wireless transmitter 500, where the resonant circuit 506 may detect or receive encoded signals when a compatible device responds to the test signal. The charging device may be configured to activate one or more coils in at least one charging cell after receiving a response signal defined by standard, convention, manufacturer or application. In some examples, the compatible device can respond to a ping by communicating received signal strength such that the charging device can find an optimal charging cell to be used for charging the compatible device.

Passive ping techniques may use the voltage and/or current measured or observed at the LC node 510 to identify the presence of a receiving coil in proximity to the charging pad of a device adapted in accordance with certain aspects disclosed herein. In many conventional wireless charger transmitters, circuits are provided to measure voltage at the LC node 510 or to measure the current in the LC network. These voltages and currents may be monitored for power regulation purposes or to support communication between devices. In the example illustrated in FIG. 5, voltage at the LC node 510 is monitored, although it is contemplated that current may additionally or alternatively be monitored to support passive ping in which a short pulse is provided to the resonant circuit 506. A response of the resonant circuit 506 to a passive ping (initial voltage V₀) may be represented by the voltage (V_{LC}) at the LC node 510, such that:

$${V}_{L C} = {V}_{0} {e}^{- \left(\frac{ω}{2 Q}\right) t}$$

According to certain aspects disclosed herein, coils in one or more charging cells may be selectively activated to provide an optimal electromagnetic field for charging a compatible device. In some instances, coils may be assigned to charging cells, and some charging cells may overlap other charging cells. In the latter instances, the optimal charging configuration may be selected at the charging cell level. In other instances, charging cells may be defined based on placement of a device to be charged on a surface of the charging device. In these other instances, the combination of coils activated for each charging event can vary. In some implementations, a charging device may include a driver circuit that can select one or more cells and/or one or more predefined charging cells for activation during a charging event.

In certain aspects of the disclosure, a wireless charging system that is actively engaged in a charging procedure may suspend the charging procedure to avoid or mitigate interference with a nearby radio frequency (RF) transmitter or receiver. In one example, a charging current provided to one or more power transmitting coils may be temporarily terminated to enable a key fob interrogation signal to be transmitted by a key fob radio in an automobile or other vehicle. The key fob interrogation signal may be referred to herein as a key fob ping or fob ping.

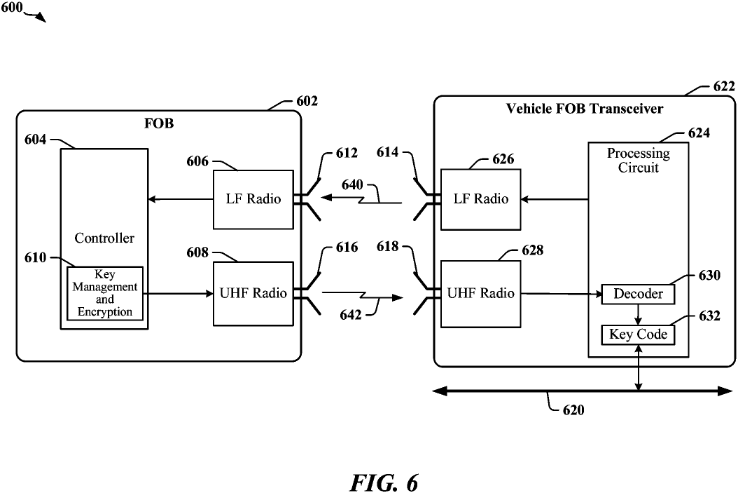

A key fob that is a component of a keyless entry system may be used to gain access or enable operation of a vehicle. In some examples, a memory in a key fob is encoded with information that authorizes a bearer of the key fob to unlock and lock the vehicle and, in at least some examples, to operate the vehicle. FIG. 6 illustrates a keyless entry system 600 that includes a key fob 602 that can communicate wirelessly with a vehicular fob transceiver 622. The vehicular fob transceiver 622 may be operated by a keyless entry system. In some instances, the vehicular fob transceiver 622 may be communicatively coupled to a communication bus 620 operated in accordance with a standards-defined or proprietary protocol. In the illustrated example, the vehicular fob transceiver 622 includes a processing circuit 624 that is configured to detect and identify the key fob 602 when the key fob 602 is proximately located, and to determine when the key fob 602 is no longer proximately located. The key fob 602 may be proximately located when it is located within reception range of RF signals transmitted by the vehicular fob transceiver 622 or while RF signals transmitted by the key fob 602 can be received by the vehicular fob transceiver 622. In one example, the range of RF signals used to manage keyless entry is between 15 and 70 feet (approximately 5-21 meters).

In some examples, the vehicular fob transceiver 622 may detect presence of the key fob 602 by transmitting a short-duration, low frequency (LF) signal (the LF signal 640) from an LF radio transmitter 626 through an LF antenna 614. The key fob 602 may receive the LF signal 640 at an LF antenna 612 that is coupled to an LF radio receiver 606. Upon identifying the LF signal 640 as a key fob interrogation signal, the key fob 602 may respond by transmitting identifying information in an ultra-high frequency signal (the UHF signal 642) through an antenna 616 driven by a UHF radio transmitter 608. A controller 604 in the key fob 602 may generate the identifying information using an encrypted key code provided by a key management circuit or module 610. A UHF receiver 628 in the vehicular fob transceiver 622 may receive the UHF signal 642 through a UHF antenna 618. A decoder 630 in the processing circuit 624 may decode the UHF signal 642 to derive the key code 632 and the processing circuit 624 may unlock or enable operation of the vehicle after verifying the validity or authenticity of the key code. The UHF signal 642 may be transmitted at a frequency defined by a regulatory authority. In one example, the UHF signal 642 may be transmitted at a frequency of 315 MHz. In another example, the UHF signal 642 may be transmitted at a frequency of 433.92 MHz.

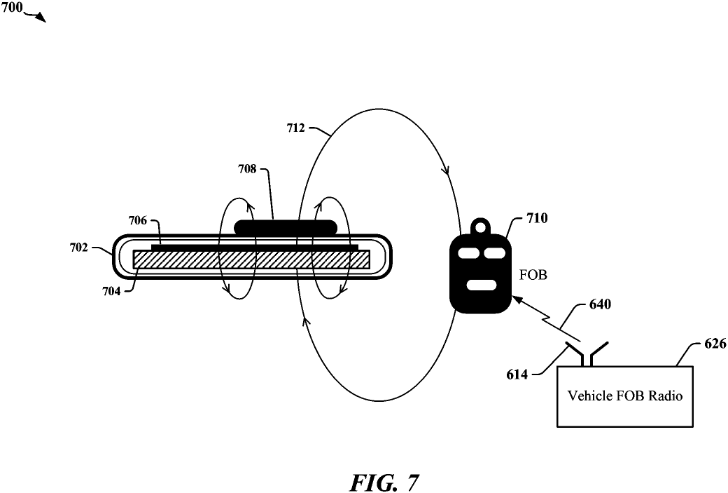

The LF signal 640 may be transmitted in a frequency range used by a wireless charging system to wirelessly transmit power through a charging surface. With reference to the scenario 700 illustrated in FIG. 7, a wireless charging device 702 and a receiving device 708 may be relatively thin. In some instances, the wireless charging device 702 may have depth that is close to the thickness of a printed circuit board 704 and one or more metallization layers 706 in which transmitting coils are provided. Some magnetic flux 712 may couple a transmitting coil with a key fob 710. The wireless charging device 702 may generate flux at a frequency that lies within a band of frequencies between 100-200 kHz. The vehicular fob transceiver 622 may transmit the LF signal 640 in the same 100-200 kHz band of frequencies. The magnetic flux 712 generated by the wireless charging device 702 can generate interference with the LF signal 640 transmitted by the vehicular fob transceiver 622 and may block the operation of the key fob 710 in some instances. Certain aspects of this disclosure relate to systems, methods, techniques and adaptations that can prevent a wireless charging device from interfering with the LF signal 640. In certain aspects of the disclosure, a wireless charging system may suspend charging operations while the LF signal 640 is being transmitted by a vehicular fob transceiver 622.

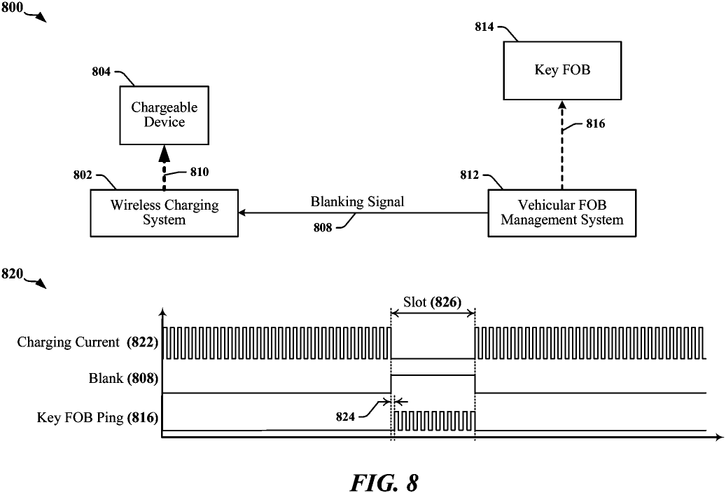

FIG. 8 illustrates a first example 800 in which a wireless charging system 802 may be configured to suspend charging operations when a key fob interrogation signal 816 is transmitted by a vehicular fob management system 812. The timing diagram 820 illustrates signaling associated with the key fob interrogation signal 816. In the first example 800, a chargeable device 804 is receiving power through magnetic flux 810 produced by the wireless charging system 802. The magnetic flux 810 is produced by one or more transmitting coils in response to a charging current 822.

The vehicular fob management system 812 may be communicatively coupled to the wireless charging system 802 and may be configured to provide a signal (the blanking signal 808) indicating transmission of a key fob interrogation signal 816 to the key fob 814 by the vehicular fob management system 812. In the example illustrated in FIG. 8, the blanking signal 808 is provided in signaling state of a general-purpose input/output (GPIO) pin or pad that is coupled by a physical interconnect to a corresponding GPIO pin or pad of the wireless charging system 802. In other examples, the blanking signal 808 may be communicated in a message transmitted over a communication bus operated in accordance with a standards-defined or proprietary protocol. Examples of standards-defined protocols include Controller Area Network (CAN) protocols, Local Interconnect Network (LIN) protocols, universal serial bus (USB) protocols, Inter-Integrated Circuit (I2C or I²C) protocols and Improved Inter-Integrated Circuit (I3C) protocols.

The wireless charging system 802 may cease charging operations while the blanking signal 808 is asserted, creating a slot 826 in which the key fob interrogation signal 816 can be transmitted without interference from the magnetic flux 810 produced by the transmitting coils of the wireless charging system 802. In some instances, the vehicular fob management system 812 may introduce a delay 824 after the assertion of the blanking signal 808 and before transmitting the key fob interrogation signal 816 in order to allow the magnetic flux 810 to dissipate.

The wireless charging system 802 may determine a charging configuration for each chargeable device placed on a charging surface of the wireless charging system 802. A charging configuration may select a single power transmitting coil or a set of power transmitting coils to be used to charge a chargeable device and the level of charging current to be provided to each selected power transmitting coil during a charging operation. The slot 826 is initiated when the charging currents defined by the charging configuration are shut off. When the slot 826 is to be terminated the charging currents may be restored at the levels defined by the charging configuration in effect before the slot 826 commenced. That is, the same charging configuration is used without implementing chargeable device discovery procedures to select power transmitting coils or negotiation with a chargeable device to select a level of charging current.

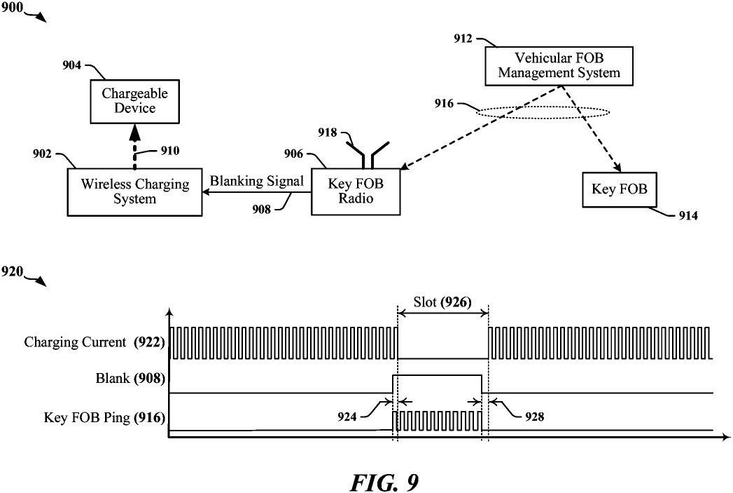

FIG. 9 illustrates a second example 900 in which a wireless charging system 902 may be configured to suspend charging operations when a key fob interrogation signal 916 is transmitted by a vehicular fob management system 912. The timing diagram 920 illustrates signaling associated with the key fob interrogation signal 916. In this second example 900, a chargeable device 904 is receiving power through magnetic flux 910 produced by the wireless charging system 902. The magnetic flux 910 is produced by one or more transmitting coils in response to a charging current 922. The wireless charging system 902 includes or is coupled to a radio receiver 906 that includes or uses an antenna 918 that can be tuned to receive signals in the band of frequencies used for the key fob interrogation signal 916. In one example, the radio receiver 906 is provided as an external device coupled to the wireless charging system 902. In other examples, the radio receiver 906 is included or deployed within the wireless charging system 902. In one example, the radio receiver 906 may use an idle transmitting coil as an antenna. In one example, the radio receiver 906 may include an idle tank circuit coupled to one or more transmitting coils. In some examples, the radio receiver 906 may include a detector that uses canceling techniques to isolate a received signal representative of the key fob interrogation signal 916 by canceling signals representative of magnetic flux generated by one or more power transmitting coils of the wireless charging system 902.

The radio receiver 906 may be configured to provide a signal (the blanking signal 908) indicating reception of a key fob interrogation signal 916 to the key fob 914 from the vehicular fob management system 912. In the example illustrated in FIG. 9, the blanking signal 908 is provided in signaling state of a GPIO pin or pad that is coupled by a physical interconnect to a corresponding GPIO pin or pad of the wireless charging system 902. In other examples, blanking signal 908 may be communicated in a message transmitted over a communication bus operated in accordance with a standards-defined or proprietary protocol. Examples of standards-defined protocols include CAN bus protocols, LIN bus protocols, USB protocols, I2C protocols and I3C protocols.

The wireless charging system 902 may cease charging operations while the blanking signal 908 is asserted, creating a slot 926 in which the key fob interrogation signal 916 can be transmitted without continuous interference from the magnetic flux 910 produced by the transmitting coils of the wireless charging system 902. The wireless charging system 902 may cease charging operations by suspending or terminating the charging current 922. The magnetic flux 910 may continue for an initial duration 924 until the radio receiver 906 asserts the blanking signal 908 and until the wireless charging system 902 has ceased power transmission. The resumption of the charging current 922 and generation of magnetic flux 910 may be delayed by a duration 928 corresponding to the time taken for the radio receiver 906 to detect the cessation of the key fob interrogation signal 916 and to de-assert the blanking signal 908.

The wireless charging system 902 may determine a charging configuration for each chargeable device placed on a charging surface of the wireless charging system 902. A charging configuration may select a single power transmitting coil or a set of power transmitting coils to be used to charge a chargeable device and the level of charging current to be provided to each selected power transmitting coil during a charging operation. The slot 926 is initiated when the charging currents defined by the charging configuration are shut off. When the slot 926 is to be terminated the charging currents may be restored at the levels defined by the charging configuration in effect before the slot 926 commenced. That is, the same charging configuration is used without implementing chargeable device discovery procedures to select power transmitting coils or negotiation with a chargeable device to select a level of charging current.

Certain aspects of this disclosure provide an antenna that can be used to receive signals in the band of frequencies used for key fob interrogation. The antenna may correspond to the antenna 918 illustrated in FIG. 9. The antenna may have the form of a loop antenna overlaid on the surface of a wireless charging device. For example, a loop antenna may substantially enclose the power transfer areas provided in a charging surface 400 (see FIG. 4). Near-field communication (NFC) signaling, including key fob interrogation signaling, may be absorbed and attenuated by the transmitting coils of the charging surface 400. It may be desirable or necessary to provide a loop antenna with a large surface area or volume in order to collect sufficient radiated energy to successfully detect a key fob interrogation signal or other NFC signal. However, an antenna with a broad cross-sectional area is likely to be susceptible to eddy currents and other currents induced by the transmitting coils of the charging surface 400.

In accordance with one aspect of the disclosure, a composite loop antenna is provided using multiple traces that are provided in a substantially parallel physical alignment. The traces may be connected in parallel at each end and may follow the same path across a surface of the charging device. In some implementations, the parallel traces that follow the same path may be regarded as a multi-strand wire for the purposes of circuit or signal analysis. The number of traces used to form the multi-strand wire may be determined based on application or design requirements. In some examples, thirty or more traces are included in the multi-strand wire can exceed

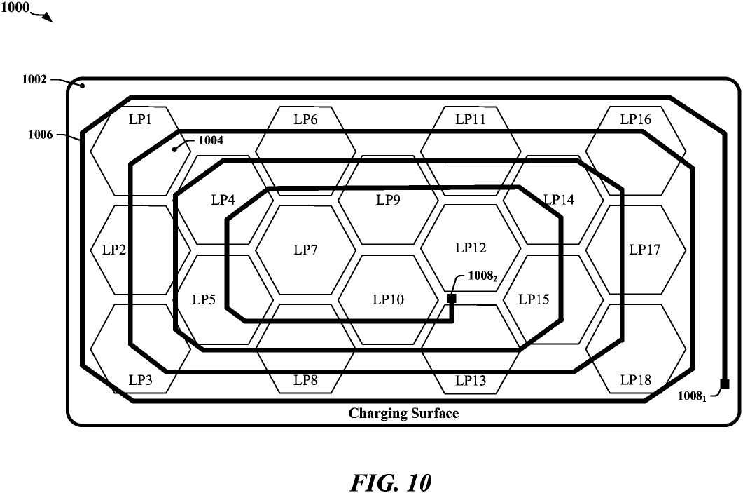

FIG. 10 illustrates an effective layout of a loop antenna 1006 provided in a multidevice wireless charging system 1000 that has been configured or adapted in accordance with certain aspects of this disclosure. FIG. 10 shows the effective path of the loop antenna 1006 on the charging surface 1002 of the multidevice wireless charging system 1000. Multiple charging cells (LP1-LP18) are deployed across the charging surface 1002. In the illustrated example, each charging cell in the example, including the LP1 cell 1004, is formed using one or more concentric coils (see FIGS. 1-4 for examples of charging cells and charging coils). The illustrated loop antenna 1006 is formed as a spiral, terminated by contact pads, through-holes, or terminals 1008₁, 1008₂.

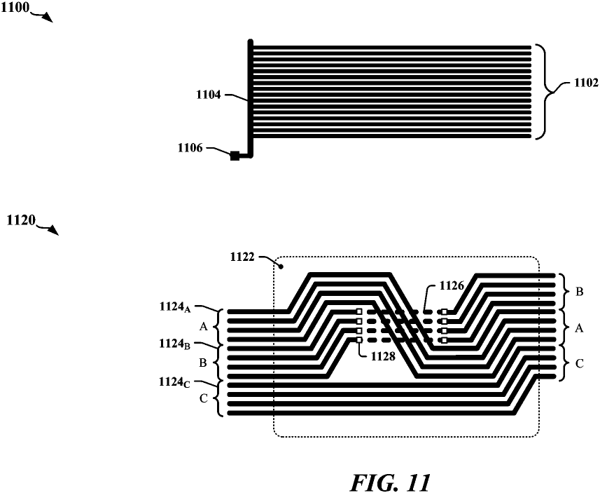

FIG. 11 illustrates a first example of a segment 1100 of a loop antenna provided in accordance with certain aspects of this disclosure. In the illustrated example, traces 1102 are provided in substantial parallel alignment across a charging surface of a wireless charging device. In the illustrated segment 1100, the traces 1102 number a total of 16 traces terminated by a common conductive element or connecting trace 1104. The illustrated segment 1100 may represent a terminating end of the loop antenna and may be coupled to a wireless receiver or transmitter through a pad, through-hole, or terminal 1106.

In some implementations the traces 1102 may be provided in true or complete parallel alignment, where each trace maintains a uniform separation and from each of its neighbors throughout the length of the loop antenna. Substantial parallel alignment may be found where, as illustrated in FIG. 10, for example, the loop antenna is segmented and includes straight segments joined at angled turns in which geometric symmetry or alignment varies. In this example, the width of traces along an angled turn may be greater than the width of the traces along a straight segment. In the latter example, the traces may be arranged in parallel along the straight segments, which can constitute a great majority of the length of the loop antenna. Substantial parallel alignment may also be found when traces deviate from their respective paths to avoid a through-hole or physical component attached to a printed circuit board that carries the traces. In one example, one or more traces may be implemented on multiple sides of a printed circuit board, and these traces may deviate from their respective paths when transitioning through a printed circuit board.

In some implementations, the traces may be configured such that each trace switches or swap relative positions at certain points. In one example, trace switching or swapping may include switching groups of traces between certain defined paths. In some instances, inner and outer paths are defined for the loop antenna and a group of traces following an inner path on one segment may be switched to an outer path in a following segment. In some instances, the paths may correspond to relative distances from the center of a loop antenna segment and a first group of traces following a first path in a first segment of the loop antenna may swap relative location at a boundary between segments with a second group of traces that follows a second path in the first segment of the loop antenna.

Trace swapping or switching may be used to normalize the lengths of the traces in the loop antenna. For example, normalizing the length of two or more traces in the loop antenna may include causing the traces to switch between inner and outer paths in various segments such that the overall length of the traces within the loop antenna is the same within a defined tolerance. The tolerance may be expressed as the maximum variation of path length between any two traces. In one example, the tolerance may be defined as a percentage of the path length. In some examples, the tolerance may be defined as a percentage of the maximum lateral (two dimensional) separation of traces in a segment of the loop antenna. In some examples, the tolerance may be defined based on the resistivity of the traces or may be expressed as the maximum difference in resistance between any two traces.

Trace swapping or switching may reduce electromagnetic interference in the loop antenna. Trace swapping or switching may be configured to ensure that all traces have similar exposure to NFC signaling and/or interfering signals. In some examples, certain types of electromagnetic interference may be cancelled when each trace is exposed to the same level of magnetic field attributable to the interfering signal.

FIG. 11 illustrates a second example of a segment 1120 of a loop antenna that enables trace switching in accordance with certain aspects of this disclosure. Twelve traces of segment 1120 are depicted. The twelve traces are divided into groups 1124_{A}, 1124_{B}, 1124c that each include four traces. In other implementations, groups may be defined with different number of traces. The groups need not include identical numbers of traces as other groups in the segment. In some instances, trace swapping may be performed for each individual trace, rather than groups of traces.

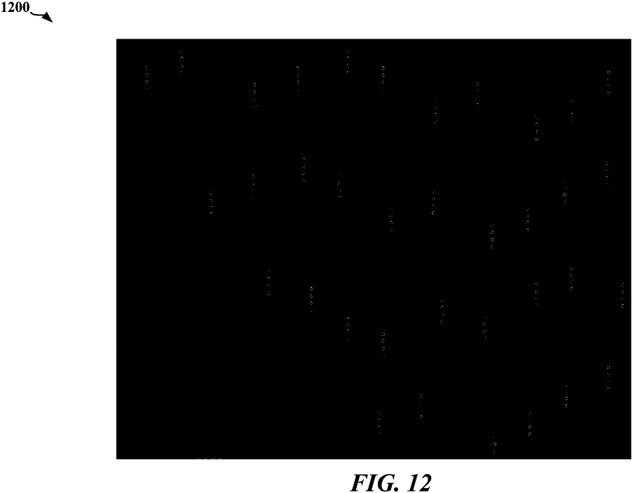

In the illustrated example, the relative position of two of the groups 1124_{A}, 1124_{B} are swapped at a crossover intersection 1122 and all three groups 1124_{A}, 1124_{B}, 1124_{C}are translated vertically in the crossover intersection 1122, at least in the context of the drawing. Swapping of groups 1124_{A}, 1124_{B} is facilitated using traces on two sides of a printed circuit board to allow groups 1124_{A}, 1124_{B} to cross paths. In the illustrated example, group 1124_{B} includes traces 1126 that are located on a different layer of a printed circuit board, and coupled using through-holes 1128. FIG. 12 shows an example of trace swapping in a section of a printed circuit board 1200. The trace swapping illustrated in the printed circuit board 1200 corresponds to the trace swapping illustrated in segment 1120. The resultant loop antenna is spiral in shape and loops the charging surface three or more times.

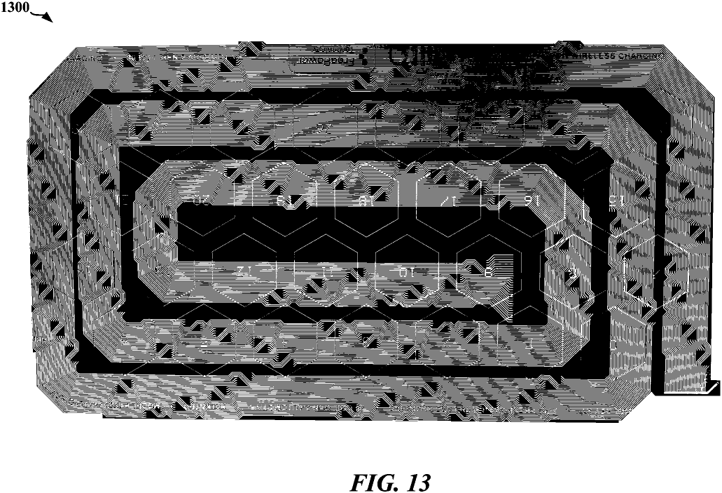

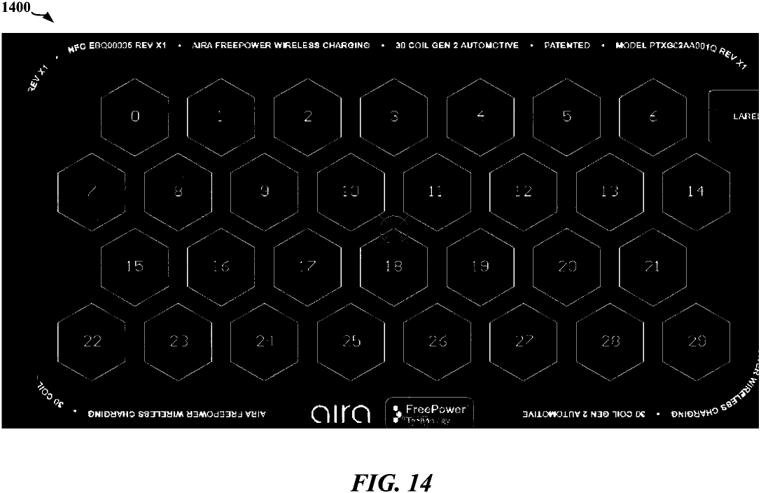

FIG. 13 illustrates an example of a top layer of a printed circuit board 1300 that may include segments similar to the segments 1100, 1120 illustrated in FIG. 11. FIG. 14 illustrates a two-layer printed circuit board 1400, each layer including segments similar to the segments 1100, 1120 illustrated in FIG. 11. The printed circuit board 1400 illustrated in FIG. 14 permits a larger number of traces to be combined into a loop antenna. In both printed circuit board 1300 and printed circuit board 1400, it can be seen that the traces that form the loop antenna swap positions at regular intervals.

A loop antenna provided in accordance with certain aspects of this disclosure may be coupled to an NFC radio through a high-pass filter. The high-pass filter may be configured to block induced signals from the power transmitting circuits. In some instances, the loop antenna may be coupled to the NFC radio through a set of switches that can be used to block induced signals from the power transmitting circuits.

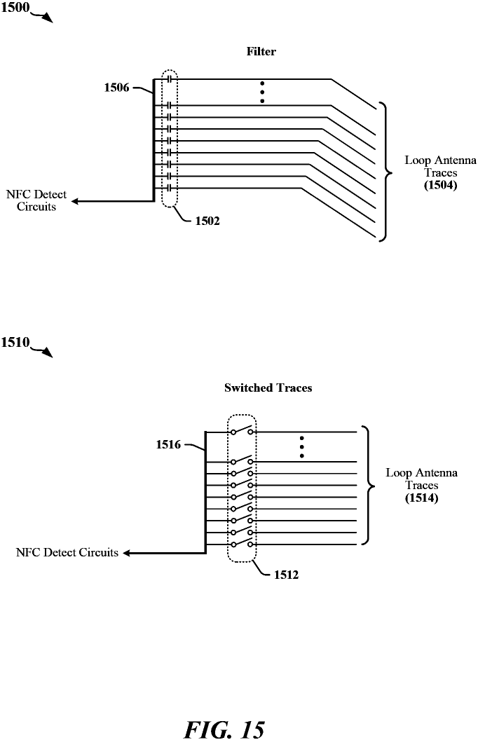

FIG. 15 illustrates examples of capacitive filtering 1500 and switching 1510 in accordance with certain aspects of this disclosure. Filtering may be accomplished using capacitors 1502 that are configured to provide a capacitance that blocks circulating currents in frequency bands associated with wireless power transfer, while passing currents in frequency bands associated with near field communication. Switches 1512 may be used to configure a loop antenna or to disconnect the loop antenna from NFC detection circuits. In some implementations, the loop antenna may be coupled to the NFC detection circuits through both the capacitors 1502 and the switches 1512. In some of these implementations, the capacitors 1502 and the switches 1512 may be located at one end of the loop antenna where the traces 1504, 1514 of the loop antenna are coupled to an interconnect or wire 1506, 1516 that carries received NFC signals to the NFC detection circuits. In some of these implementations, the capacitors 1502 and the switches 1512 may be located at different locations or ends different ends of the loop antenna.

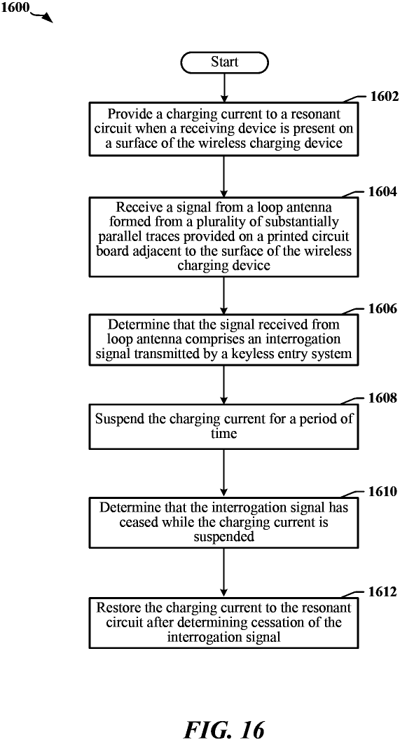

FIG. 16 is a flowchart 1600 illustrating the operation of a wireless charging device that is configured to avoid interference with key fob interrogation. The method may be performed by a controller in the wireless charging system. At block 1602, the controller may provide a charging current to a resonant circuit when a receiving device is present on a surface of the wireless charging device. At block 1604, the controller may receive a signal from a loop antenna formed from a plurality of substantially parallel traces provided on a printed circuit board adjacent to the surface of the wireless charging device. At block 1606, the controller may determine that the signal received from loop antenna comprises an interrogation signal transmitted by a keyless entry system. At block 1608, the controller may suspend the charging current for a period of time. At block 1610, the controller may determine that the interrogation signal has ceased while the charging current is suspended. At block 1612, the controller may restore the charging current to the resonant circuit after determining cessation of the interrogation signal.

In some examples, the controller may monitor a signal provided by the keyless entry system. The signaling state of the signal may indicate when the interrogation signal is being transmitted. In some examples, the controller may receive a first message from a serial bus. The controller may determine that the first message indicates that the interrogation signal is being transmitted. The controller may receive a second message from the serial bus. The second message may indicate cessation of the interrogation signal. The serial bus may be operated in accordance with a CAN protocol, LIN protocol, USB protocol, I2C protocol or an I3C protocol.

In some examples, the controller may be configured to monitor a signal provided by a radio receiver coupled to the wireless charging device. The controller may determine when a signal received at the radio receiver indicates that the interrogation signal is being transmitted by the keyless entry system. Signaling state of the signal may indicate when the interrogation signal is being transmitted. The radio receiver may be configured to cancel received signals corresponding to the charging current in the resonant circuit. The radio receiver may be tunable within the frequency band that spans 100 kHz to 200 kHz.

### Example of a Processing Circuit

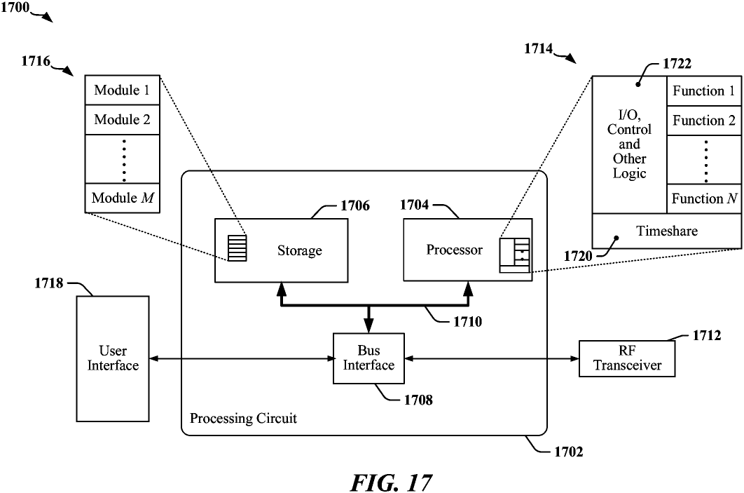

FIG. 17 illustrates an example of a hardware implementation for an apparatus 1700 that may be incorporated in a charging device or in a receiving device that enables a battery to be wirelessly charged. In some examples, the apparatus 1700 may perform one or more functions disclosed herein. In accordance with various aspects of the disclosure, an element, or any portion of an element, or any combination of elements as disclosed herein may be implemented using a processing circuit 1702. The processing circuit 1702 may include one or more processors 1704 that are controlled by some combination of hardware and software modules. Examples of processors 1704 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1704 may include specialized processors that perform specific functions, and that may be configured, augmented or controlled by one of the software modules 1716. The one or more processors 1704 may be configured through a combination of software modules 1716 loaded during initialization, and further configured by loading or unloading one or more software modules 1716 during operation.

In the illustrated example, the processing circuit 1702 may be implemented with a bus architecture, represented generally by the bus 1710. The bus 1710 may include any number of interconnecting buses and bridges depending on the specific application of the processing circuit 1702 and the overall design constraints. The bus 1710 links together various circuits including the one or more processors 1704, and storage 1706. Storage 1706 may include memory devices and mass storage devices and may be referred to herein as computer-readable media and/or processor-readable media. The storage 1706 may include transitory storage media and/or non-transitory storage media.

The bus 1710 may also link various other circuits such as timing sources, timers, peripherals, voltage regulators, and power management circuits. A bus interface 1708 may provide an interface between the bus 1710 and one or more transceivers 1712. In one example, a transceiver 1712 may be provided to enable the apparatus 1700 to communicate with a charging or receiving device in accordance with a standards-defined protocol. Depending upon the nature of the apparatus 1700, a user interface 1718 (e.g., keypad, display, speaker, microphone, joystick) may also be provided, and may be communicatively coupled to the bus 1710 directly or through the bus interface 1708.

A processor 1704 may be responsible for managing the bus 1710 and for general processing that may include the execution of software stored in a computer-readable medium that may include the storage 1706. In this respect, the processing circuit 1702, including the processor 1704, may be used to implement any of the methods, functions and techniques disclosed herein. The storage 1706 may be used for storing data that is manipulated by the processor 1704 when executing software, and the software may be configured to implement any one of the methods disclosed herein.

One or more processors 1704 in the processing circuit 1702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1706 or in an external computer-readable medium. The external computer-readable medium and/or storage 1706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1706 may also include, by way of example, a carrier wave, a transmission line, and any other suitable medium for transmitting software and/or instructions that may be accessed and read by a computer. Computer-readable medium and/or the storage 1706 may reside in the processing circuit 1702, in the processor 1704, external to the processing circuit 1702, or be distributed across multiple entities including the processing circuit 1702. The computer-readable medium and/or storage 1706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1706 may maintain and/or organize software in loadable code segments, modules, applications, programs, etc., which may be referred to herein as software modules 1716. Each of the software modules 1716 may include instructions and data that, when installed or loaded on the processing circuit 1702 and executed by the one or more processors 1704, contribute to a run-time image 1714 that controls the operation of the one or more processors 1704. When executed, certain instructions may cause the processing circuit 1702 to perform functions in accordance with certain methods, algorithms and processes described herein.

Some of the software modules 1716 may be loaded during initialization of the processing circuit 1702, and these software modules 1716 may configure the processing circuit 1702 to enable performance of the various functions disclosed herein. For example, some software modules 1716 may configure internal devices and/or logic circuits 1722 of the processor 1704 and may manage access to external devices such as a transceiver 1712, the bus interface 1708, the user interface 1718, timers, mathematical coprocessors, and so on. The software modules 1716 may include a control program and/or an operating system that interacts with interrupt handlers and device drivers, and that controls access to various resources provided by the processing circuit 1702. The resources may include memory, processing time, access to a transceiver 1712, the user interface 1718, and so on.

One or more processors 1704 of the processing circuit 1702 may be multifunctional, whereby some of the software modules 1716 are loaded and configured to perform different functions or different instances of the same function. The one or more processors 1704 may additionally be adapted to manage background tasks initiated in response to inputs from the user interface 1718, the transceiver 1712, and device drivers, for example. To support the performance of multiple functions, the one or more processors 1704 may be configured to provide a multitasking environment, whereby each of a plurality of functions is implemented as a set of tasks serviced by the one or more processors 1704 as needed or desired. In one example, the multitasking environment may be implemented using a timesharing program 1720 that passes control of a processor 1704 between different tasks, whereby each task returns control of the one or more processors 1704 to the timesharing program 1720 upon completion of any outstanding operations and/or in response to an input such as an interrupt. When a task has control of the one or more processors 1704, the processing circuit is effectively specialized for the purposes addressed by the function associated with the controlling task. The timesharing program 1720 may include an operating system, a main loop that transfers control on a round-robin basis, a function that allocates control of the one or more processors 1704 in accordance with a prioritization of the functions, and/or an interrupt driven main loop that responds to external events by providing control of the one or more processors 1704 to a handling function.

In one implementation, the apparatus 1700 includes or operates as a wireless charging apparatus that has a battery charging power source coupled to a driver circuit, a plurality of charging cells and a controller, which may be included in the one or more processors 1704. The plurality of charging cells may be configured to provide a charging surface. In each charging cell, at least one transmitting coil may be configured to direct an electromagnetic field through a charge transfer area. The driver circuit may be configured to provide a charging current to the transmitting coils. The apparatus 1700 may include a resonant circuit that includes one or more transmitting coils and a driver circuit configured to provide a charging current to the plurality of transmitting coils. The controller may be configured to provide a charging current to the resonant circuit when a receiving device is present on a surface of the wireless charging device, determine that a signal received from the loop antenna comprises an interrogation signal transmitted by a keyless entry system, suspend the charging current for a period of time, determine that the interrogation signal has ceased while the charging current is suspended, and restore the charging current to the resonant circuit after determining cessation of the interrogation signal.

In various examples, the controller is further configured to monitor a signal provided by the keyless entry system. The signaling state of the signal may indicate when the interrogation signal is being transmitted. The controller may be further configured to determine that a first message received from a serial bus indicates that the interrogation signal is being transmitted. The controller may be further configured to receive a second message from the serial bus, the second message indicating cessation of the interrogation signal. The serial bus may be operated in accordance with a CAN protocol, LIN protocol, USB protocol, I2C protocol or I3C protocol.

In some examples, the wireless charging device has a radio receiver and the controller may be further configured to monitor a signal provided by a radio receiver coupled to the wireless charging device. The signaling state of the signal may indicate when the interrogation signal is being received from the keyless entry system. The radio receiver may be configured to cancel received signals corresponding to the charging current in the resonant circuit. The radio receiver may be tunable within the frequency band that spans 100 kHz to 200 kHz.

In some implementations, the storage 1706 maintains instructions and information where the instructions are configured cause a controller to provide a charging current to a resonant circuit when a receiving device is present on a surface of the wireless charging device, receive a signal from a loop antenna formed from a plurality of substantially parallel traces provided on a printed circuit board adjacent to the surface of the wireless charging device, determine that the signal received from the loop antenna comprises an interrogation signal transmitted by a keyless entry system, suspend the charging current for a period of time, determine that the interrogation signal has ceased while the charging current is suspended and restore the charging current to the resonant circuit after determining cessation of the interrogation signal.

In one example, the instructions are configured to cause the controller to monitor a signal provided by the keyless entry system. The signaling state of the signal may indicate when the interrogation signal is being transmitted.

In some examples, the instructions are configured to cause the controller to receive a first message from a serial bus. The first message may indicate that the interrogation signal is being transmitted. The instructions may be configured to cause the controller to receive a second message from the serial bus, the second message indicating cessation of the interrogation signal. The serial bus may be operated in accordance with a CAN protocol, LIN protocol, USB protocol, I2C protocol or I3C protocol.

In some examples, the instructions are configured to cause the controller to monitor a signal provided by a radio receiver coupled to the wireless charging device. The signaling state of the signal may indicate when the interrogation signal is received from the keyless entry system. The radio receiver may be configured to cancel received signals corresponding to the charging current in the resonant circuit. The radio receiver may be tunable within the frequency band that spans 100 kHz to 200 kHz.
1. A method for operating a wireless charging device, comprising: providing a charging current to a resonant circuit when a receiving device is present on a surface of the wireless charging device; receiving a signal from a loop antenna formed from a plurality of substantially parallel traces provided on a printed circuit board adjacent to the surface of the wireless charging device; determining that the signal received from the loop antenna comprises an interrogation signal transmitted by a keyless entry system; suspending the charging current for a period of time; determining that the interrogation signal has ceased while the charging current is suspended; and restoring the charging current to the resonant circuit after determining cessation of the interrogation signal.
2. The method as described in clause 1, further comprising: monitoring a signal provided by the keyless entry system, wherein signaling state of the signal indicates when the interrogation signal is being transmitted.
3. The method as described in clause 1, further comprising: determining that a first message received from a serial bus indicates that the interrogation signal is being transmitted.
4. The method as described in clause 3, further comprising: determining that a second message received from the serial bus indicates a cessation in transmission of the interrogation signal.
5. The method as described in clause 3 or clause 4, wherein the serial bus is operated in accordance with a Controller Area Network (CAN) protocol, Local Interconnect Network (LIN) protocol, universal serial protocol (USB) protocol, Inter-Integrated Circuit (I2C) protocol or Improved Inter-Integrated Circuit (I3C) protocol.
6. The method as described in clause 1, further comprising: determining that a signal received at a radio receiver coupled to the wireless charging device indicates that the interrogation signal is being transmitted.
7. The method as described in clause 6, wherein the radio receiver is configured to cancel received signals corresponding to the charging current in the resonant circuit.
8. The method as described in clause 6 or clause 7, wherein the radio receiver is tunable within a frequency band that spans 100 kHz to 200 kHz.
9. A wireless charging device, comprising: a resonant circuit that includes one or more power transmitting coils deployed across a surface of the wireless charging device; a loop antenna formed from a plurality of substantially parallel traces provided on a printed circuit board adjacent to the surface of the wireless charging device; a driver circuit configured to provide a charging current to the one or more power transmitting coils; and a controller configured to: provide a charging current to the resonant circuit when a receiving device is present on the surface of the wireless charging device; determine that a signal received from the loop antenna comprises an interrogation signal transmitted by a keyless entry system; suspend the charging current for a period of time; determine that the interrogation signal has ceased while the charging current is suspended; and restore the charging current to the resonant circuit after determining cessation of the interrogation signal.
10. The wireless charging device as described in clause 9, wherein the controller is further configured to: monitor a signal provided by the keyless entry system, wherein signaling state of the signal indicates when the interrogation signal is being transmitted.
11. The wireless charging device as described in clause 9, wherein the controller is further configured to: determine that a first message received from a serial bus indicates that the interrogation signal is being transmitted.
12. The wireless charging device as described in clause 11, wherein the controller is further configured to: determine that a second message received from the serial bus indicates a cessation in transmission of the interrogation signal.
13. The wireless charging device as described in clause 11 or clause 12, wherein the serial bus is operated in accordance with a Controller Area Network (CAN) protocol, Local Interconnect Network (LIN) protocol, universal serial protocol (USB) protocol, Inter-Integrated Circuit (I2C) protocol or Improved Inter-Integrated Circuit (I3C) protocol.
14. The wireless charging device as described in clause 9, further comprising a radio receiver coupled to the wireless charging device, wherein the controller is further configured to: determine when a signal received at the radio receiver indicates that the interrogation signal is being transmitted.
15. The wireless charging device as described in clause 14, wherein the radio receiver is configured to cancel received signals corresponding to the charging current in the resonant circuit.
16. The wireless charging device as described in clause 14 or clause 15, wherein the radio receiver is tunable within a frequency band that spans 100 kHz to 200 kHz.
17. A processor readable storage medium comprising instructions configured to cause a processing circuit to: cause a charging current to be provided to a resonant circuit when a receiving device is present on a surface of a wireless charging device; receive a signal from a loop antenna formed from a plurality of substantially parallel traces provided on a printed circuit board adjacent to the surface of the wireless charging device; determine that the signal received from the loop antenna comprises an interrogation signal transmitted by a keyless entry system; cause the charging current to be suspended for a period of time; determine that the interrogation signal has ceased while the charging current is suspended; and cause the charging current to be restored to the resonant circuit after determining cessation of the interrogation signal.
18. The processor readable storage medium as described in clause 17, further comprising instructions configured to cause the processing circuit to: monitor a signal provided by the keyless entry system, wherein signaling state of the signal indicates when the interrogation signal is being transmitted.
19. The processor readable storage medium as described in clause 17, further comprising instructions configured to cause the processing circuit to: determine that a first message received from a serial bus indicates that the interrogation signal is being transmitted; and determine that a second message received from the serial bus indicates a cessation in transmission of the interrogation signal.
20. The processor readable storage medium as described in clause 17, further comprising instructions configured to cause the processing circuit to: determine that a signal received at a radio receiver coupled to the wireless charging device indicates that the interrogation signal is being transmitted.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for operating a wireless charging device, comprising:
providing a charging current to a resonant circuit when a receiving device is present on a surface of the wireless charging device;
receiving a signal from a loop antenna formed from a plurality of substantially parallel traces provided on a printed circuit board adjacent to the surface of the wireless charging device;
determining that the signal received from the loop antenna comprises an interrogation signal transmitted by a keyless entry system;
suspending the charging current for a period of time;
determining that the interrogation signal has ceased while the charging current is suspended; and
restoring the charging current to the resonant circuit after determining cessation of the interrogation signal.

2. The method of claim 1, further comprising:
monitoring a signal provided by the keyless entry system, wherein signaling state of the signal indicates when the interrogation signal is being transmitted.

3. The method of claim 1, further comprising:
determining that a first message received from a serial bus indicates that the interrogation signal is being transmitted.

4. The method of claim 3, further comprising:
determining that a second message received from the serial bus indicates a cessation in transmission of the interrogation signal.

5. The method of claim 3, wherein the serial bus is operated in accordance with a Controller Area Network (CAN) protocol, Local Interconnect Network (LIN) protocol, universal serial protocol (USB) protocol, Inter-Integrated Circuit (I2C) protocol or Improved Inter-Integrated Circuit (I3C) protocol.

6. The method of claim 1, further comprising:
determining that a signal received at a radio receiver coupled to the wireless charging device indicates that the interrogation signal is being transmitted.

7. The method of claim 6, wherein the radio receiver is configured to cancel received signals corresponding to the charging current in the resonant circuit.

8. The method of claim 6, wherein the radio receiver is tunable within a frequency band that spans 100 kHz to 200 kHz.

9. A wireless charging device, comprising:
a resonant circuit that includes one or more power transmitting coils deployed across a surface of the wireless charging device;
a loop antenna formed from a plurality of substantially parallel traces provided on a printed circuit board adjacent to the surface of the wireless charging device;
a driver circuit configured to provide a charging current to the one or more power transmitting coils; and
a controller configured to:
provide a charging current to the resonant circuit when a receiving device is present on the surface of the wireless charging device;
determine that a signal received from the loop antenna comprises an interrogation signal transmitted by a keyless entry system;
suspend the charging current for a period of time;
determine that the interrogation signal has ceased while the charging current is suspended; and
restore the charging current to the resonant circuit after determining cessation of the interrogation signal.

10. The wireless charging device of claim 9, wherein the controller is further configured to:
monitor a signal provided by the keyless entry system, wherein signaling state of the signal indicates when the interrogation signal is being transmitted.

11. The wireless charging device of claim 9, wherein the controller is further configured to:
determine that a first message received from a serial bus indicates that the interrogation signal is being transmitted.

12. The wireless charging device of claim 11, wherein the controller is further configured to:
determine that a second message received from the serial bus indicates a cessation in transmission of the interrogation signal.

13. The wireless charging device of claim 11, wherein the serial bus is operated in accordance with a Controller Area Network (CAN) protocol, Local Interconnect Network (LIN) protocol, universal serial protocol (USB) protocol, Inter-Integrated Circuit (I2C) protocol or Improved Inter-Integrated Circuit (I3C) protocol.

14. The wireless charging device of claim 9, further comprising a radio receiver coupled to the wireless charging device, wherein the controller is further configured to:
determine when a signal received at the radio receiver indicates that the interrogation signal is being transmitted.

15. The wireless charging device of claim 14, wherein the radio receiver is configured to cancel received signals corresponding to the charging current in the resonant circuit.

16. The wireless charging device of claim 14, wherein the radio receiver is tunable within a frequency band that spans 100 kHz to 200 kHz.

17. A processor readable storage medium comprising instructions configured to cause a processing circuit to:
cause a charging current to be provided to a resonant circuit when a receiving device is present on a surface of a wireless charging device;
receive a signal from a loop antenna formed from a plurality of substantially parallel traces provided on a printed circuit board adjacent to the surface of the wireless charging device;
determine that the signal received from the loop antenna comprises an interrogation signal transmitted by a keyless entry system;
cause the charging current to be suspended for a period of time;
determine that the interrogation signal has ceased while the charging current is suspended; and
cause the charging current to be restored to the resonant circuit after determining cessation of the interrogation signal.

18. The processor readable storage medium of claim 17, further comprising instructions configured to cause the processing circuit to:
monitor a signal provided by the keyless entry system, wherein signaling state of the signal indicates when the interrogation signal is being transmitted.

19. The processor readable storage medium of claim 17, further comprising instructions configured to cause the processing circuit to:
determine that a first message received from a serial bus indicates that the interrogation signal is being transmitted; and
determine that a second message received from the serial bus indicates a cessation in transmission of the interrogation signal.

20. The processor readable storage medium of claim 17, further comprising instructions configured to cause the processing circuit to:
determine that a signal received at a radio receiver coupled to the wireless charging device indicates that the interrogation signal is being transmitted.
